(19) United States
(12) Patent Application Publication
(10) Pub. No.: US 2026/0307807 A1
(43) Pub. Date: Oct. 8, 2026

(54) TRAY TABLE FOR AIRCRAFT SEAT, DEPLOYABLE BY A COMBINED MOVEMENT LIMITING ITS OVERALL SIZE

(71) Applicant: AIRBUS ATLANTIC, ROCHEFORT (FR)

(72) Inventor: Frédéric CLOET, ROCHEFORT (FR)

(21) Appl. No.: 19/642,368

(22) Filed: Apr. 8, 2026

(30) Foreign Application Priority Data
Apr. 8, 2025 (FR) FR2503696

(51) Int. Cl. B64D 11/06

(52) U.S. Cl. CPC B64D 11/0638

(57) ABSTRACT

The invention relates to a tray table (100) for an aircraft passenger seat (200), comprising a deployable plate (10), a first support (20), on which the plate is hinged, and an interface (40) for fastening in a seat environment, said table comprising a second support (30) on which the first support (20) is slidably mounted along a translational direction (T) parallel to the plane of the plate; the second support (30) being slidably mounted on the interface (40) along the same translational direction (T), so that said supports are telescopically deployable; the plate (10) being rotatably mounted on the first support (20), about an axis of rotation (R) perpendicular to the plane of the plate; the movements of sliding of the supports (20, 30) and of rotation of the plate (10) being coupled, so that said plate performs a progressive and automatic rotation during deployment thereof and stowage thereof.

### TECHNICAL FIELD

The present invention relates to the field of airplane cabin interior fittings, in particular deployable tray tables. More particularly, it relates to a tray table deployable by a combined, translation—rotation, movement allowing reducing its overall size.

The invention finds a direct, but non-exclusive, application in passenger seats of higher classes (business class and first class) of commercial airplanes.

### STATE OF THE ART

Since the emergence of commercial aviation, the interior fitting of aircraft cabins has been a major challenge for improving passenger comfort and experience, especially in business and first classes. One of the key features to enhance this comfort is the tray tables, which provide passengers with a stable surface for meals, work or leisure while flying. Originally, the tray tables were simply integrated into the backrest of the seat in front of the passenger. In this classical configuration, the table can be folded back from a vertical stowing position to a horizontal position for use. However, this solution has significant ergonomic constraints, in particular because it depends on the inclination of the front backrest: if the backrest is too inclined, the useful space for comfortable use of the table is dramatically reduced. To meet these constraints, a second generation of tray tables has emerged, integrated directly into the seat or an adjacent side console. In this case, the table is generally stowed in an armrest or in a console specifically provided for this purpose, in a retractable and deployable form. Typically, these tables are extracted by a pivoting or linear translational movement, by virtue of a hinged mechanism that guides the table to its final position facing the passenger. However, these solutions introduce other significant challenges. On the one hand, they often involve complex mechanisms, comprising multiple hinges or guide rails, likely to lead to high manufacturing and maintenance costs. On the other hand, the table stored lengthwise, due to the dimensional constraints imposed by limited spaces in the cabin, generally has a narrow and elongate shape when deployed. This narrow and deep geometry proves uncomfortable for the passenger, as it limits the working width in front of them, thus reducing the comfort of use when eating or working.

In addition, when the tray tables are deployed, they often block the space in front of the passenger, forcing the latter to completely stow the table when they want to leave their seat to go into the corridor or elsewhere in the cabin. This is particularly disadvantageous on long-haul flights, where passengers frequently travel to the toilet, to stretch their legs or simply to interact with other cabin occupants. In addition, the necessary stowage of the table before exiting the seat creates repetitive and stressful movements, which can be perceived as annoying by passengers, especially when these movements have to be performed frequently. These technical and ergonomic drawbacks, widely recognized by aircraft cabin interior fitting specialists, have been the subject of various solution attempts. By way of example, some devices known from prior art provide combined rotation or translation mechanisms, in order to make the table more ergonomic when deployed. However, despite the improvements made, these systems generally remain cumbersome, requiring accommodation that is larger than necessary, and still imposing annoying handling on the passenger. A thorough examination of current solutions further confirms that existing mechanisms do not allow the passenger to leave their seat without folding down the tray table beforehand, or only with great difficulty.

Thus, despite these attempts to improve the configuration and use of the tray tables, no known solution offers a satisfactory compromise combining both optimal ergonomic use, maximum compactness of the stowing device and total freedom of movement of the passenger when they wish to leave their seat while the table is in the deployed position. The current state of the art therefore remains awaiting a technical solution that simultaneously solves these constraints and offers a significantly improved passenger experience in terms of user comfort, convenience and optimal integration into the limited space available on board commercial aircraft.

### DISCLOSURE OF THE INVENTION

The present invention aims to overcome all or part of the drawbacks of prior art set out above by providing an innovative solution, optimizing ergonomics of a tray table while reducing its overall size.

For this purpose, one object of the present invention is an aircraft passenger seat tray table, comprising a deployable plate, forming an operating surface for the passenger, a first support, to which the plate is hinged, and an interface for fastening said table in a seat environment. This tray table is remarkable in that it comprises a second support on which the first support is slidably mounted along a translational direction parallel to the plane of the plate; in that the second support is slidably mounted on the interface along the same translational direction, so that said supports are telescopically deployable; in that the plate is rotatably mounted on the first support, about an axis of rotation perpendicular to the plane of the plate; and in that the movements of sliding of the supports and of rotation of the plate are coupled, so that said plate performs a progressive and automatic rotation during deployment thereof and stowage thereof.

According to one aspect of the invention, the table has a stowed position, in which the plate is stored integrally and longitudinally under the interface, and a fully deployed position in which the plate is placed transversely in front of the seat.

According to one aspect of the invention, the table further has an intermediate position in which the plate is partially deployed along an oblique direction relative to the seat, said plate leaving a distance relative to the seat sufficient to allow the passenger to exit both from the left and from the right depending on the location of an exit corridor.

According to one embodiment, the first support is slidably mounted inside the second support, said supports being thus nestable.

According to one embodiment, the first support comprises an end receiving the plate and configured to raise said plate above the second support and below the interface.

According to one embodiment, the interface comprises on its lower face slide rails for the second support.

More particularly, the rails are inclined relative to a longitudinal direction of the interface to increase the travel of the second support.

According to one embodiment, the table comprises an actuation mechanism configured to ensure simultaneous sliding of the first and second supports and synchronized and progressive rotation of the plate, said mechanism comprising: a first pinion connected to the plate and mounted in a first notched belt connected to the first support, said first notched belt sliding on a cam connected to the second support, said second support comprising a second belt translationally driving the first support via a first slide stage, said second belt itself being translationally driven by a second pinion of the second support cooperating with a rack of the interface, said second pinion driving the second support via a second slide stage.

Advantageously, the cam has a curvature defining the path of the first belt and the trajectory of the plate.

Another object of the invention is an airplane passenger seat unit, comprising a seat and a tray table as set forth, installed in front of said seat.

The fundamental concepts of the invention having just been set out above in their most elementary form, other details and features will emerge more clearly upon reading the following description and with reference to the appended drawings, giving as a non-limiting example an embodiment of a tray table in accordance with the principles of the invention.

### BRIEF DESCRIPTION OF THE DRAWINGS

The figures are given merely for illustration for a better understanding of the invention without limiting its scope. The different elements may be represented schematically and are not necessarily plotted to scale. Throughout the figures, identical or equivalent elements bear the same reference numeral.

Thus, it is illustrated in:

FIG. 1: a perspective view of a tray table in its fully deployed position according to an embodiment of the invention;

FIG. 2: another perspective, bottom view of the tray table;

FIG. 3: a perspective bottom view of the tray table in its stowed position;

FIG. 4: isometric perspective views of the tray table in the stowed position (a), in the semi-deployed position (b) leaving a sufficient distance for the passenger to exit, and in the fully deployed position (c);

FIG. 5: Top views of the tray table in the previous three positions;

FIG. 6: a simplified kinematic scheme of the tray table in these three previous positions;

FIG. 7: a top view showing the trajectory of the tray table when deployed or stowed, with different successive positions of the plate.

### DETAILED DESCRIPTION OF EMBODIMENTS

In the embodiment described hereinafter, reference is made to an airplane passenger seat tray table, allowing a passenger to use the useful surface of this table to eat their meal or place personal objects. This table is primarily intended for passenger seats in the upper classes (business class and first class).

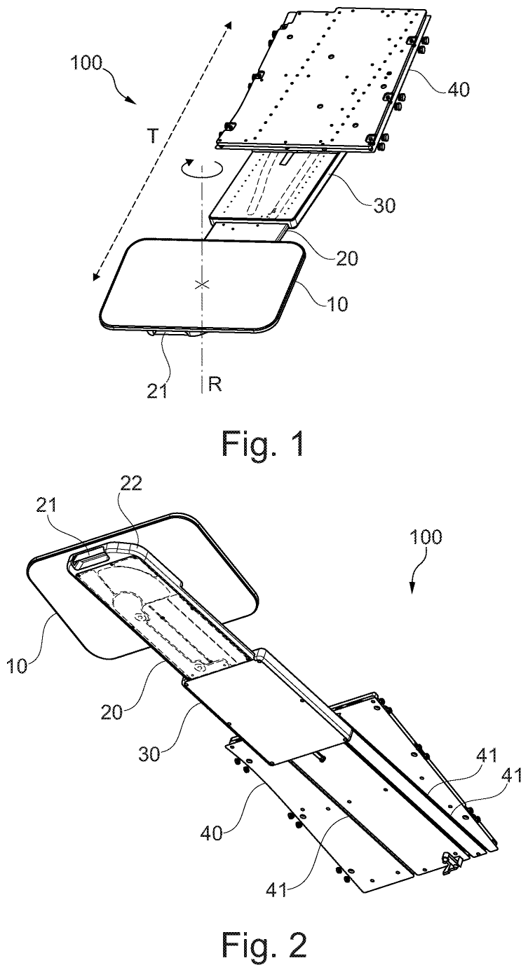

In the context of the present invention, the terms “tray table” or simply “table” mean the functional assembly formed by the plate itself, making up the useful surface intended to receive objects such as meal trays, electronic devices or personal effects of the passenger, as well as all the mechanical actuation elements configured to enable stowage and deployment of said table, including the fastening interface intended to ensure the integration of the table into the passenger seat environment. This functional assembly forms a coherent and autonomous system. FIG. 1 shows a tray table 100 for a passenger seat, in a fully deployed position, thus allowing precise viewing of the constituent elements and their mechanical interactions. The tray table 100 comprises a plate 10, a first support 20 on which the plate is rotatably mounted, a second support 30 cooperating with the first one by sliding nest, and a fastening interface 40 on which the second support is slidably mounted, the latter being intended to ensure mechanical connection between the tray table 100 and its seat environment, not represented, for example a space in the opposite seat provided to this end.

The plate 10 constitutes the useful surface intended to receive especially a meal, a laptop or any other personal object of the passenger. This plate has an overall rectangular shape, advantageously rounded at the corners to improve comfort of use.

The plate 10 is rotatably mounted to the first support 20 about an axis of rotation R substantially perpendicular to the plane of the plate 10. This characteristic allows the table 10 to pivot in its plane in order to modify its orientation and provide the passenger with an ergonomically optimized surface when the tray table 100 is fully deployed. Indeed, this rotation is automatic and occurs gradually during deployment, by being coupled to sliding of the supports 20 and 30, until the plate 10 is in front of the passenger along its length as represented in FIG. 1.

The first support 20 has a generally elongate and planar shape, intended to ensure stable mechanical connection with the plate 10. This first support 20 is slidably mounted inside the second support 30 along a translation direction T parallel to the plane of the plate 10 and extending along a longitudinal direction of the supports 20 and 30, thereby allowing a controlled longitudinal extension of the tray table 100 when it moves from its stowed position into its deployed position and vice versa.

The second support 30 constitutes an intermediate structural element in the kinematics of the tray table 100. It has an elongate general shape, configured to slidably accommodate the first support 20 along the translational direction T. Complementarily, this second support 30 is itself slidably mounted inside the fastening interface 40 along the same translational direction T.

This double sliding configuration between the supports 20 and 30 and between the support 30 and the interface 40 thus makes it possible to achieve a particularly advantageous telescopic effect, ensuring a significant useful travel for the tray table 100 while limiting to a strict minimum the overall size in the stowed position as will be explained later.

Finally, the fastening interface 40 ensures the mechanical integration of the tray table 100 into its immediate environment around the passenger seat, typically under the screen of the opposite seat in a space provided to this end. This fastening interface 40 comprises suitable fastening means, such as quick fasteners or any other equivalent device allowing firm and stable fastening to the seat environment. It is dimensioned so as to fully accommodate the plate 10 and the supports 20 and 30 in the stowed position and allow an optimum deployment without disturbing the passenger or negatively affecting the overall aesthetics of the seat.

Finally, it will be noticed that the table 100 comprises in the lower part additional elements such as a handle 21 integral with the first support 20, thus facilitating its handling, especially for easily initiating deployment and stowing kinematics of said table.

Mechanical interactions between these different components of the tray table 100 thus ensure complex and perfectly controlled kinematics, making it possible to effectively combine rotation and translation in order to offer the passenger an adapted ergonomic surface, while strictly limiting the overall size of the table in the stowed position.

FIG. 2 shows the tray table 100 at a different angle pointing downwards, in order to better view the handle 21 and elements of the sliding mechanism.

The handle 21, ideally placed to facilitate gripping by the passenger, has an ergonomic shape allowing easy and intuitive handling, in particular during initial phases of the deployment movement or when stowing the table.

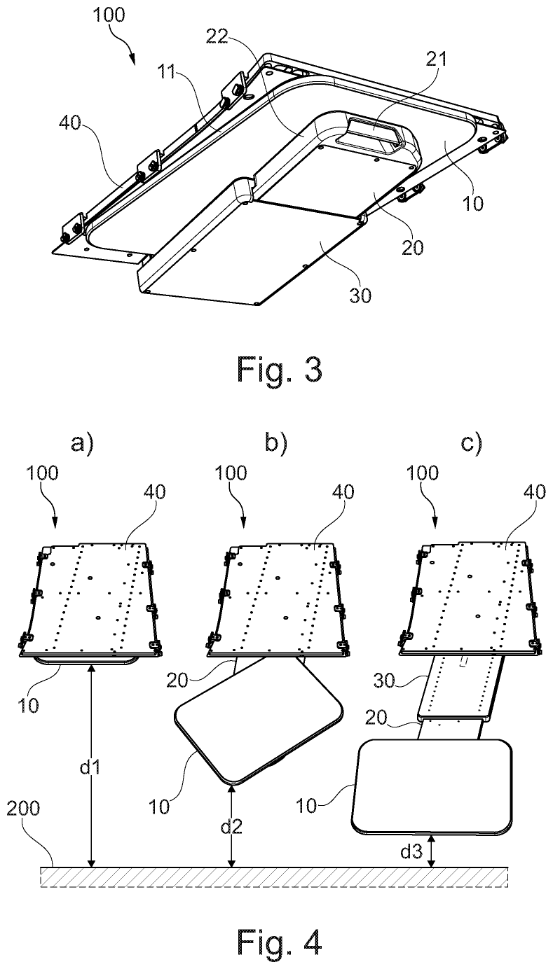

FIG. 2 also shows the extended shape of the first support 20 which extends over the entire width of the plate 10 and terminates with an end 22 raising said tray above the level of the second support 30 and below the level of the interface 40 to allow it to be stowed between the two as represented in FIG. 3.

The sliding cooperation between the first support 20 and the second support 30 is ensured by an inner mechanical guide, advantageously consisting of sliding elements not visible herein but arranged inside said supports. This guide guarantees smooth sliding while ensuring mechanical rigidity, essential to the stability of the plate 10 when it bears a load.

Still with reference to FIG. 2, the fastening interface 40 comprises integrated sliding rails 41, provided in its lower face. The rails 41 ensure guidance of the second support 30 during sliding. These slide rails 41 are preferably made of materials with low friction and high wear resistance.

The slide rails 41 are not strictly parallel to the longitudinal axis of the fastening interface 40, but have a slight angle of inclination relative thereto. This inclination towards the large diagonal of the plane of the interface 40 makes it possible to increase the effective length of the rails 41, without increasing the total longitudinal overall size of the interface 40, thus providing a more extended sliding travel. The angle of inclination of the rails 41 is precisely determined to guarantee that at the end of travel, when the tray table 100 is completely stowed, the plate 10 is entirely stored under the interface 40.

FIG. 3 represents the tray table 100 in its stowed position, in a perspective bottom view, making it possible in particular to observe how the plate 10 is fully concealed under the fastening interface 40 after stowing. As previously discussed, this compact configuration in the stowed position is made possible by the slight inclination of the slide rails, which ensures that the plate 10 comes to be positioned fully under the interface 40 when sliding reaches its final stop.

In this stowed position, the plate 10 is oriented along its depth, i.e. along its largest side 11. This specific orientation directly results from the particular kinematics of the table 100, wherein the rotation of the table 10 about its axis of rotation is automatically coupled to sliding of the supports 20 and 30 during the stowing movement initiated by the passenger by pushing the handle 21. Thus, the plate 10 gradually pivots during its sliding movement, moving from a position of use in front of the passenger, as represented in FIGS. 1 and 2, to this optimized stowing position under the interface 40.

Moreover, the end 22 of the first support 20 slightly raises the plate 10, thus facilitating its integration between the interface 40 and the second support 30, while ensuring sufficient space to comfortably accommodate the thickness of the plate 10 in the stowed position.

FIG. 4 shows the tray table 100 in three distinct successive positions: a stowed position in (a), an intermediate or semi-deployed position in (b), and a fully deployed position in (c). These three positions are represented opposite a passenger seat 200 depicted.

In the stowed position (a), the plate 10 is completely concealed under the fastening interface 40. In this configuration, the table 100 leaves a maximum space noted d1 between its edge and the passenger seat 200, ensuring perfect freedom of movement for the passenger to enter or exit.

The intermediate or semi-deployed position represented in (b) corresponds to a partial extension of the plate 10. This intermediately deployed position is particularly advantageous, because it creates a distance d2 between the plate 10 and the passenger seat 200, which distance remains sufficient to allow the passenger to easily leave their seat regardless of the position of the aisle, to the left or right with respect to the table 100. Furthermore, in this semi-deployed position, the useful surface of the plate 10 remains widely accessible, which allows for example the comfortable presence of a tray table or other objects necessary for the passenger. In order to ensure that the entire surface of the plate 10 is available in this intermediate position, a material removal can advantageously be provided at the level of the fastening interface 40 to avoid masking the small plate portion still partially covered, as represented in the example of FIG. 4(b).

Finally, the fully deployed position represented in (c) corresponds to the optimal configuration of use described previously with reference to FIGS. 1 and 2. In this final position, the table 100 extends as far forward as possible towards the passenger, leaving a reduced distance d3 between the table 10 and the passenger seat 200, to provide the user with a fully accessible surface in ideal ergonomic conditions for a meal, work or any other comfortable use during the flight.

Thus, the kinematics of the tray table 100 advantageously offers a particularly useful intermediate configuration, combining both sufficient space to allow the passenger to exit their seat freely and an optimized accessible useful surface.

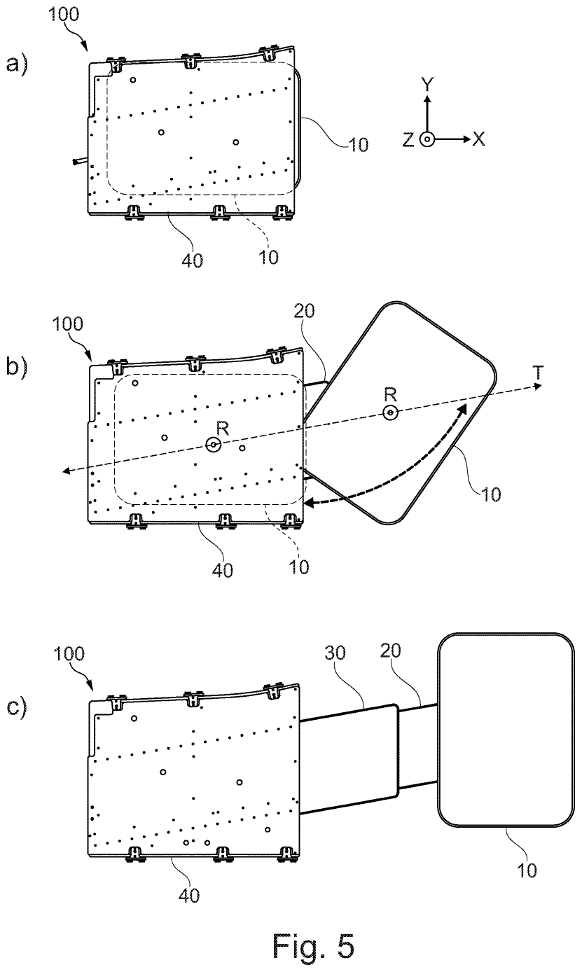

FIG. 5 represents, in a same reference frame, the three successive positions described previously, in a planar top view intended to clearly account for the different sliding travels and the rotational movement of the plate 10.

In the stowed position (a), the plate 10 is entirely concealed under the fastening interface 40, to within a border. This stowed position is represented in dashed line in order to precisely view the location of the plate 10 under the interface 40 and its maximum compactness when stowed along its largest dimension, thus reducing the stowing space required to a maximum.

By moving to the intermediate position (b), it is possible to clearly observe the combined path of sliding along the direction T and rotation of the plate 10 about the axis R which is movable with the first support 20. During this intermediate phase of the movement, the plate 10 progressively pivots with respect to the first support 20 while exiting its housing located under the interface 40.

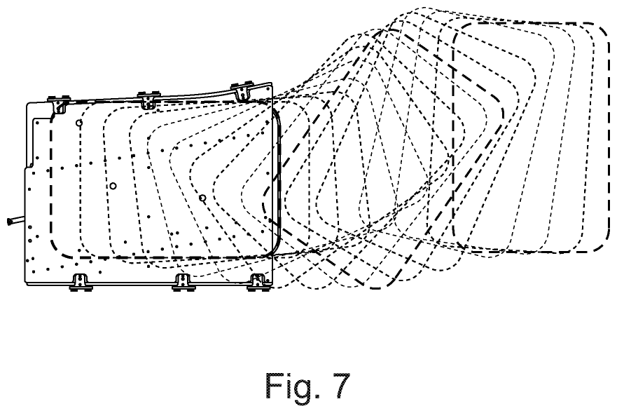

FIG. 7 more clearly represents how the rotation of the plate is performed gradually while being coupled to the longitudinal displacement.

Especially, this particular kinematics allows the plate 10 to clear almost all of its useful surface, when it is in the intermediate position, while freeing up sufficient space to allow the passenger to exit.

Finally, in the fully deployed position (c), the plate 10 is facing the passenger, oriented in parallel to the passenger along its length to offer optimum ergonomics. The two supports 20 and 30 appear fully extended in telescopic sliding, clearly showing their respective contribution to the total deployment travel. This planar view clearly illustrates the total length achieved by the telescopic mechanism and highlights the maximum amplitude of movement from the stowed position to the fully deployed final position.

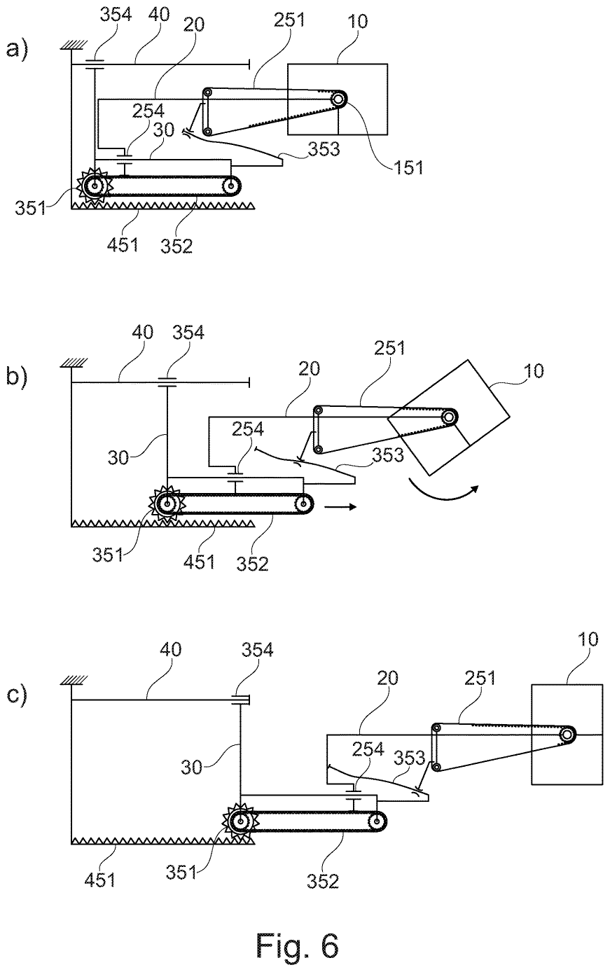

FIG. 6 shows the kinematic scheme of the actuation mechanism of the tray table 100, in its previously-described three successive positions: stowed in (a), intermediate or semi-deployed in (b) and fully deployed in (c).

It should be set out that the kinematic scheme represented is not to scale. In particular, the stowed position (a) is intentionally represented in a stretched manner in order to improve legibility of the mechanism. In reality, in this configuration, the plate 10 as well as the supports 20 and 30 are largely superimposed under the interface 40, which would considerably complicate understanding the operation if the actual proportions were respected. Hence, the sole purpose of this schematic representation is to highlight the structure and the kinematics of the actuation mechanism, regardless of its real overall size.

The actuation mechanism especially comprises two sliding stages guided by a double slide comprising a first slide 354, between the second support 30 and the interface 40, and a second slide 254 between the second support 30 and the first support 20. This double-stage configuration ensures maximum compactness of the assembly in the stowed position (a).

During deployment to the intermediate position (b), the gradual exit of the table is ensured by a first mechanical synchronization system comprising a fixed rack 451 connected to the interface 40, a pinion 351 meshing with this rack, and a notched belt 352 mounted to this pinion 351 and driving the first support 20. This first system makes it possible to control sliding of the two slide stages 354 and 254, according to a law determined by the mechanical reduction existing between the pinion 351 and the pulley integral with the belt 352. Thus, for a distance D traveled by the first slide stage 354, a reduced distance D/n (with n generally around 2 in the illustrated example) is traveled simultaneously by the second stage 254, ensuring a smooth and coordinated movement of the two supports 20 and 30 during deployment or stowing.

The plate 10 is connected to the first support 20 by a second synchronization system ensuring its controlled rotation during the deployment or stowing movement. This second system comprises a pinion 151 rigidly connected to the plate 10 and a notched belt 251 connecting this pinion 151 to the first support 20. The rotation of the plate 10, and therefore of the pinion 151, is controlled by the interaction of the belt 251 with a cam 353 fastened to the second support 30.

The mechanical contact between the cam 353 and the belt 251 thus guides progressive rotation of the plate 10, allowing it to avoid any potential obstacle from the immediate environment of the seat, such as a door or a particular curvature of the seat environment, while ensuring precise ergonomic positioning at each deployment step.

Indeed, as the second support 30 moves under the action of the first system, contact or clutching with the cam 353 causes the pinion 151 to rotate gradually via the belt 251. The plate 10 thus pivots about its axis of rotation as the tray table 100 exits (or enters). The shape of the cam 353 can be adapted (by varying its curvature) to precisely adjust the rotational law of the plate 10, for example in order to avoid any obstacle.

In the last, fully deployed, position (c), the mechanism reaches its maximum extension with the plate 10 ideally oriented facing the passenger. At this stage, the pinion 351 has traveled the entire rack 451, which corresponds to a complete extension of the second support 30 with respect to the interface 40, while the belt 352 has simultaneously positioned the first support 20 at its final position on the slide 254. The plate 10 has completed its rotation by virtue of the pinion 151 driven by the belt 251 in interaction with the cam 353.

Thus, the kinematics of the tray table 100 can be described as follows:
In the stowed position, the plate 10 is completely concealed under the interface 40, with the slides 354 and 254 retracted to the maximum. The pinion 151 and the belt 251 are in abutment on the cam 353 in a closed position, the belt 251 being wedged so as to keep the plate 10 in a position parallel to the interface 40.
In the intermediate position, the first support 20 and the second support 30 have started their differential sliding movement, controlled by the rack 451, the pinion 351 and the belt 352. Simultaneously, the plate 10 starts its rotation under the action of the pinion 151 and the cam 353. The thick curved arrow indicates the angular trajectory of the plate, while the right arrow shows translation of the second support 30.
In the fully deployed position, the slides 354 and 254 have reached their maximum extension, imposing on the plate 10 its final orientation (typically perpendicular or almost perpendicular to the interface 40) defined by the geometry of the cam 353. The reduction ratio n then results in precise synchronization between the distance traveled by the second support 30 and that traveled by the first support 20. The plate 10 is in its service position, ready for use by the passenger.

The actuation mechanism thus allows synchronization between telescopic sliding and rotation of the plate 10, ensuring harmonious and controlled movement between the different positions of the table 100. This mechanism has further been designed with adjustment of some parameters such as the curvature of the cam 353 or the value of the reduction ratio n between the pinion 351 and the belt 352 in order to precisely adapt the final trajectory of the plate to the specific constraints of the seat environment into which the table is integrated.

According to an advantageous additional embodiment, the tray table 100 can integrate a partial ejection mechanism, similar to that used in some drawers, allowing the passenger to slightly exit the table by simply exerting a slight pressure on the table 10 when it is in the stowed position. This pressure automatically releases an internal locking mechanism, which throws the plate 10 forward over a short distance. Thus, the passenger can easily grip the handle 21 in order to manually continue deployment of the table to the intermediate or fully deployed positions, significantly improving ergonomics of use of the device.

Furthermore, when the tray table 100 reaches its fully deployed position, a mechanical locking system makes it possible to firmly block rotation of the table 10, thus ensuring its stability and preventing any unintentional rotation likely to hinder the passenger during use. Only the reverse translation, activated by the user when they push the support 20 to stow the table, makes it possible to release locking and automatically restore the coupled rotation of the plate 10 to its stowed position.

1. A tray table for aircraft passenger seat, comprising a deployable plate, forming an operating surface for the passenger, a first support, to which the plate is hinged, and an interface for fastening said table in a seat environment, said table being characterized in that:
it comprises a second support on which the first support is slidably mounted along a translational direction (T) parallel to the plane of the plate;
in that the second support is slidably mounted on the interface along the same translational direction (T), so that said supports are telescopically deployable;
in that the plate is rotatably mounted on the first support, about an axis of rotation (R) perpendicular to the plane of the plate;
and in that the movements of sliding of the supports and rotation of the plate are coupled, such that said plate performs a gradual and automatic rotation during its deployment and stowing; and,
an actuation mechanism configured to ensure simultaneous sliding of the first and second supports and synchronized and progressive rotation of the plate, said mechanism comprising: a first pinion connected to the plate and mounted in a first notched belt connected to the first support, said first notched belt sliding on a cam connected to the second support, said second support comprising a second belt translationally driving the first support via a first slide stage, said second belt being itself translationally driven by a second pinion of the second support cooperating with a rack of the interface, said second pinion driving the second support via a second slide stage.

2. The tray table according to claim 1, characterized in that it has a stowed position, in which the plate is stowed integrally and longitudinally under the interface, and a fully deployed position in which the plate is transversely placed in front of the seat.

3. The tray table according to claim 1, wherein in that it further has an intermediate position in which the plate is partially deployed along an oblique direction relative to the seat, said plate leaving a distance (d2) relative to the seat sufficient to allow the passenger to exit both from the left and from the right depending on the location of an exit corridor.

4. The tray table according to claim 1, wherein the first support is slidably mounted inside the second support, said supports being thus nestable.

5. The tray table according to claim 1, wherein the first support comprises an end receiving the plate and configured to raise said plate above the second support and below the interface.

6. The tray table according to claim 1, wherein the interface comprises on its lower face rails for sliding the second support.

7. The tray table according to claim 6, wherein the rails are inclined relative to a longitudinal direction of the interface to increase the travel of the second support.

8. (canceled)

9. The tray table according to claim 1, wherein the cam has a curvature defining the path of the first belt and the trajectory of the plate.

10. An airplane passenger seat unit, comprising a seat and wherein the passenger seat unit comprises a tray table according to claim 1 installed in front of said seat.
